(19) United States
(12) Patent Application Publication
(10) Pub. No.: US 2013/0139574 A1
(43) Pub. Date: Jun. 6, 2013

(54) Devices for heating and cooling a capillary liquid chromatographic system

(71) Applicant: Sau Lan Tang Staats, Hockessin, DE (US)

(72) Inventor: Sau Lan Tang Staats, Hockessin, DE (US)

(73) Assignee: Phoenix S&T, Inc., Chester, PA (US)

(21) Appl. No.: 13/487,202

(22) Filed: Jun. 2, 2012

Related U.S. Application Data
(60) Provisional application No. 61/520,032, filed on Jun. 3, 2011.
(60) Provisional application No. 61/521,568, filed on Aug. 9, 2011.

(51) Int. Cl. G01N 30/30

(52) U.S. Cl. CPC G01N 30/30
USPC 73/61.57

(57) ABSTRACT

Devices for heating and cooling chromatographic columns, transfer tubing, fittings and accessories and can also be placed next to the mass spectrometer's inlet region are disclosed. These devices have the advantage of allowing the user to dramatically reduce the post-column dead-volume while using the heating or cooling devices, a necessity for low-flowrate liquid chromatography. These devices also do not require the user to heat or cool the entire column with fittings to achieve optimized benefits for chromatography.

### CROSS REFERENCE TO RELATED APPLICATION

The present application claims the benefit of U.S. patent application Ser. No. 61/520,032, filed Jun. 3, 2011 and U.S. patent application Ser. No. 61/521,568 filed Aug. 9, 2011, which are hereby incorporated by reference in their entirety.

### TECHNICAL FIELD

The present application relates to devices that improve the performance of low-flow-rates high-performance liquid chromatography.

### BACKGROUND OF THE INVENTION

High performance liquid chromatography (HPLC) is a technique used widely to separate a mixture of chemical species in a liquid mobile phase based on their interactions with the stationary phase of the particles packed into a tube or capillary called a column. For many separation applications, it is desirable to have the temperature of the chromatographic column elevated above room temperature to gain the benefits of faster peak elution, better chromatographic resolution, better peak shape especially for hydrophobic eluting species, better retention times reproducibility, lower back pressure, reduced carry-over, etc. In the art, the most common column heater is in the form of an oven which is an enclosed, well insulated space typically much larger than the column itself. In another instance of the art when the column is a fused silica capillary, the column heater may be an extremely flexible slender cylindrical sleeve not much larger in diameter but longer than the fused silica capillary column itself that may damage the sharp nanospray emitter during column insertion into the sleeve if the emitter is an integrated front end of the capillary column. Still another kind of column heater in the art is of the “blanket” type which wraps around the column and also its end fittings. These blanket-style column heaters are also much larger in size than the capillary column itself.

The large sizes of the oven-style or blanket-style column heaters are undesirable since the column contained within these heaters have to be placed further away from the mass spectrometer inlet than is desirable. In the case of the ovens which are typically integrated into their respective liquid chromatography (LC) pumps, the distance between the heated column and the mass spectrometer inlet where the eluates are detected is large because the LC pump cannot be placed close enough to the mass spectrometer. The large sizes of both the oven-style and the blanket-style heaters are primarily due to the large amount of insulation used to maintain a constant temperature within the heater, and the perceived need to encase the entire column and its connection fittings inside the oven proper. For nano-liquid chromatography (nanoLC) where the flow rates for the eluate are typically under 1 microliter/minute, it is desirable to have the LC column placed as close to the detector, a mass spectrometer, as possible to eliminate post-column “dead volume” that broadens the chromatographic peaks.

It is an object of the present application to disclose devices that heat or cool capillary columns to achieve excellent chromatographic results by heating or cooling the entire column with its connection fittings, or just a part of the column. Columns of different lengths and outside diameters may be heated or cooled in the same device if desired; and the devices, because of their small sizes and built-in column positioning features, allow these columns to be placed at their optimized positions in front of the mass spectrometers for detection. Moreover, these disclosed devices are not prone to damaging the columns during column insertion into the devices. It is also an object of the present application to disclose devices that allow the column temperature to be changed, for example, from an elevated temperature to ambient temperature, quickly for certainly applications such as hydrogen/deuterium exchange. It is also the object of the present application to disclose devices that allow the column and associated plumbing and attachments to be heated to above room temperature or cooled to below room temperature in the same device.

### SUMMARY OF THE INVENTION

The invention discloses devices for heating or cooling a capillary column and also fittings and tubing commonly used in a liquid chromatography system to a preset temperature constant to about 0.2° C. The devices comprise a structurally stiff or bendable tube or two-dimensional surfaces which are heated or cooled by the appropriate active heating or cooling elements. A capillary LC column or a part of a capillary column, and in some instances, its fittings and tubing when placed in close thermal contact of the heating or cooling surfaces, or surrounded by the heated or cooled surfaces, attain the temperature of the heated and cooled surfaces. The disclosed devices are small enough so that the capillary column within can be placed in a position in front of the mass spectrometer detector to optimize sensitivity and peak shape by reducing post-column dead volume. The small sizes of the devices result from adequate but not excessive amount of thermal insulation and the realization that not the entire capillary column needs to be heated to obtain the full benefits of column heating. The heating or cooling surface, which is preferably made of copper or aluminum, is resistively heated by means known in the art, or thermoelectrically heated or cooled, and covered with a relatively thin layer of thermal insulation material such as fiberglass or a plastic material. The near constant temperature is achieved both by the finite amount of thermal insulation and the temperature controller with a proportional-integral-differentiation (PID) type of algorithm known in the art. In one embodiment of the invention, a narrow slit about 0.06 inch in width or larger along the full length of the temperature-varying tube device allows a capillary column with fittings or connectors at both ends to be inserted into a heater or cooler device sideways through the slit but with the fittings exposed to the ambient and not heated. One or more outer concentric sleeves having a similar slit in each sleeve and are made of insulating materials surround the heating tube so that all the slits of the concentric tubes can be aligned for the insertion of the column into the heater tube through the slits. After the insertion of the column, the outer sleeves can be rotated with respect to the heater tube so that the slit of the heater tube is covered by the insulating sleeves.

In another embodiment of the invention, the disclosed device regulates the temperature surrounding a capillary column to a preset temperature constant to about 0.2° C. of the preset temperature, which may be above or below ambient temperatures. The device comprises at least one temperature varying plates that are at least partially planar and are a few cm in extent, preferably from about 2 to 8 cm in width and may be up to tens of cm in length. The thickness of the temperature-varying plates can be from 0.001 inch to 0.03 inch, with the preferred range of thickness to be from 0.005 to 0.02 inch. In good thermal contact with the temperature-regulating plates are one or more temperature-varying elements such as one or more resistive heaters, a adiative heaters, thermoelectric element, or a combination of these and other similar temperature-varying elements. The plate may be flat, or may be bent or rolled in some portion to accommodate columns of a different diameter or columns with fittings that need to be heated or cooled also. In the preferred embodiment of the device, the device comprises at least one heated or cooled plate and a second plate with or without an active temperature-varying element. A gap space is formed between these two plates into which a capillary column as well as other LC fittings and tubing can be inserted to be heated or cooled. In another embodiment, the second plate is absent so that the gap space is formed by the first heated or cooled plate and thermal insulation. The width of the widest part of the gap space may be from about 0.02 inch for a bare fused silica capillary column, to up to 0.5 inch if the fittings of the column are to be heated also. If both a bare fused silica column and a column with fittings are to be heated or cooled in the same device as is often the case when a trap column is used in conjunction with a capillary column in a separation, then the gap space may have a width or diameter of up to 0.4 inch in one portion of the device and a gap space width of 0.02 to 0.06 inch in another portion of the device. An adequate but not excessive amount of thermal insulation materials for a heater and a cooler is applied to cover the temperature-varying element side of the temperature-varying plates and also surrounding the gap space. For a thermoelectric element is used in the device, an adequate heat sink an fan has to be used in addition to the thermal insulation. Fittings or apertures for securing the spray tip end of the column are also built into the cover housing of the device so that the spray tip end of the capillary LC column placed inside this device can be securely and reproducibly positioned in its optimized position in front of the mass spectrometer detector. The first and second temperature-varying plates may reside in two separate thermally insulated structures so that the two structures may be hinged or mechanically clamped together appropriately to form the gap space, or they may reside in a single folded plate with the gap space forming an opening for the insertion of the capillary column. Because the capillary column can be coiled or looped and placed into the device, the device can accommodate capillary columns many times longer than the smallest dimension of the area of the plate. In still another embodiment of the invention, a cooling aid such as a fan is attached to the housing cover of the device to help cool the temperature-varying plate and the air above it quickly to quench the temperature of the capillary column. In still another embodiment of the invention, one type of temperature-varying element resides on the first plate, while a different type of temperature varying element resides on the second plate. For example, a resistive heater is in good thermal contact with the first plate, and the cooling side of a thermoelectric heater is in good thermal contact with the second plate. Such a device can be used to heat the column to a temperature not typically achievable by using a thermoelectric element as a heater, and also cool the column to below ambient temperature. In yet another embodiment of the invention, the temperature-varying plate of the disclosed device is in thermal contact with a thermoelectric cooling element that heats or cools the disclosed device using appropriate electronic control known in the art. The near constant temperature is achieved both by the finite amount of thermal insulation and the temperature controller with a proportional-integral-differentiation (PID) type of algorithm known in the art. All the embodiments of the column heater and cooler disclosed in this invention maintain a near constant temperature in a space in which one or more capillary analytical column and the trap column of a different length and diameter for chromatographic separation can be placed with minimal risk of having any fragile parts of the column damaged, and the heater or cooler can be placed in a position in front of the mass spectrometer which is optimized for LC-MS detection.

### BRIEF DESCRIPTION OF THE DRAWING FIGURES

The present invention will be understood and appreciated more fully from the following detailed description of preferred embodiments of the present invention, taken in conjunction with the following drawings in which:

FIG. 1 is a schematic drawing of a column heater device in the form of a tube for capillary columns with end fittings.

FIG. 2: is a schematic cross-section of the column heater device for capillary column with end fittings and the outermost insulating sleeve is rotated to cover the slit for insertion of the capillary column.

FIG. 3: is a schematic drawing of a cross-section of the device comprising planar or largely planar temperature-varying plates with the exemplary components and their configuration in the device.

FIG. 4: is a schematic model of the device comprising planar or largely planar temperature-varying plates showing the invented device in a one-piece construction and an opening for inserting the column into the gap space of the device.

FIG. 5: is a cross-sectional schematic drawing of the view of the invented device comprising planar or largely planar temperature-varying plates device used for heating the column and then for fast quenching the temperature of the column after the heat has been turned off.

FIG. 6: is a schematic drawing of the temperature-varying plates of an example of the invented device that can accommodate columns of dramatically different lengths and diameters, including columns with end fittings.

### DESCRIPTION OF PREFERRED EMBODIMENTS

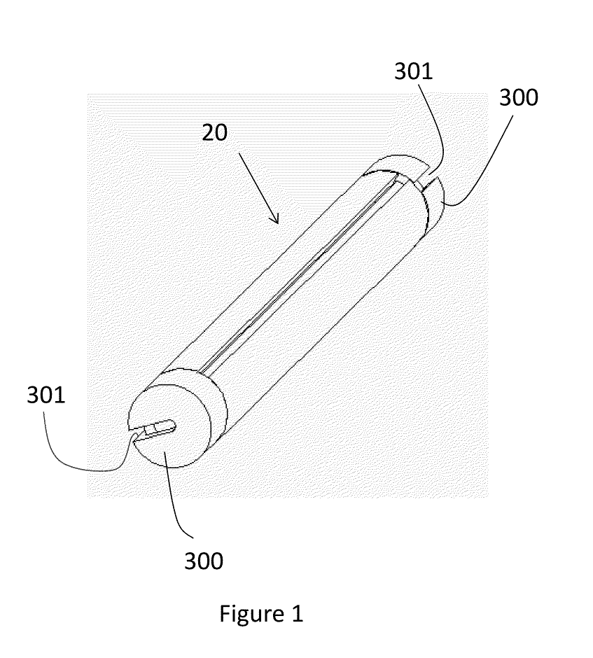

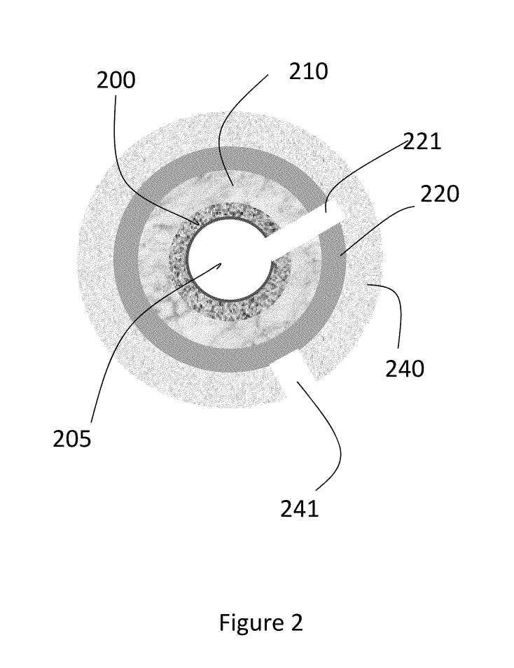

In one embodiment of the invention as shown in FIG. 1, the heater device 20 is more or less tubular in shape and is used for heating capillary columns with end fittings. Only the portion of the capillary between the end fittings is inserted into the heater device 20. At both ends of the device 20, rotatable caps 300 made preferably of PEEK are used to limit the exposure of the ends of the heater tube 200 to the ambient. The rotatable cap 300 has a slot 301 through the body of the cap 300 so that the capillary column can be inserted into the slot 301 when the slot 301 is aligned with the slits 201, 221, and 241 described below. Referring to the cross sectional drawing in FIG. 2, the heater tube 200 inside the heater 20 runs the length of the heater 20 and has a slit 201 about 0.06 to 0.1 inch down the length of the heater tube 200 which has a diameter of about 0.15 inch to 0.25 in. The heater tube 200 is resistively heated and is covered with thermal insulation 210 made of materials such as fiberglass, heat-resistant polymers such as Teflon® or Kapton® or high temperature silicone rubber, or a combination of these materials. A temperature sensor not shown in the figure is in good thermal contact with the heated air inside the heater tube by attaching the thermal sensor to a cutout in the heater tube 200. The insulation 210 does not cover the slit 201. A second tube 220 preferably made of Tefon® or PEEK also with a slit 221 from about 0.05 inch to about 0.1 inch down the length of the tube 220 is sleeved snugly over the insulation 210 so that the slit 201 and the slit 221, once they are aligned to give access 240 to the heater cavity 230, will not rotate against each other to lose the access 240. The wall thickness of the tube 220 may be from 0.01 inch to 0.09 inch, with the preferred wall thickness in the range of 0.01 inch to 0.04 inch. A third tube 240 also with a slit 241 down the whole length of the tube 240 is sleeved over the structure comprising tube 200, insulation, 210, and the second tube 220 so that the tube 250 can be rotated freely over the second tube 220. The slit 241 is aligned with the slits 201 and 221 for inserting the capillary column. Once the column is in the heater cavity 205, the tube 250 is rotated against the tube 220 so that the slit 241 is no longer aligned with the slits 201 and 221. Both the thermal energy in the heater cavity 205 and the capillary column are now kept in place inside the heater cavity 205. With this heater 20, capillary column with fixed fittings at both end can be slipped into the heater 20 with the fittings exposed to the ambient. The device 20 can be made with an overall outside diameter of about 0.5 inch.

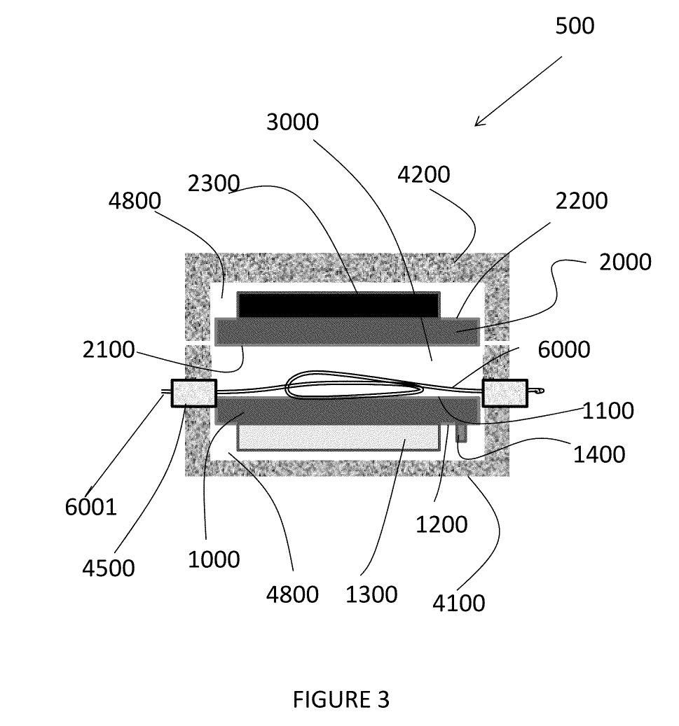

In another embodiment of the invention as shown in FIG. 3 in cross-section, the device 500 for varying the temperature of one or more capillary chromatography columns is at least in part planar in shape. The device 500 comprises a first plate 1000 and a second plate 2000. The plates 1000 and 2000 may be two separate plates, or may be two leaves of a plate that is folded so that a gap space 3000 is formed between the surfaces of the folded plate 1000.

The temperature of the surface 1100 of the plate 1000 can be varied through a variety of means in good thermal contact with the plates 1000 such as conduction heating from a heated filament 1300, radiative heating via a hot filament or an infrared lamp placed close to the plate 1000 but not in contact, or cooling through the cold side of a thermoelectric Peltier plate, a tubing carrying a coolant in good thermal contact with the plate 1000, or any other appropriate heating or cooling means known in the art. The materials that are most suitable for making the plate 1000 are thermally conducting materials such as copper, aluminum, anodized aluminum, stainless steel, and thermally conducting ceramics and the like, and the preferred materials are a copper or an aluminum plate from 0.001 inch in thickness to 0.03 inch in thickness. The preferred range of thickness of the plate 1000 is from about 0.002 inch to about 0.02 inch. A temperature sensor 140 such as a thermocouple or a similar device is attached appropriately such as with a thermal-bonding substance, a piece of temperature-appropriate tape and the like to the surface 1100, or to the other surface 1200 of the plate 1000. The second plate 2000 also contains a thermally conducting surface 2100 whose temperature can be varied by a second temperature varying element 2300 which may be similar to the temperature varying element 1300 or a different temperature element. For example, the temperature-varying element 1300 may be a resistive heater that can raise the temperature to 100° C. or higher, and the element 2300 may be the cooling side of a Peltier plate that can cool the device to 0° C. or lower. A second temperature sensor may be used but is not necessary for the plate 2000. The plates 1000 and 2000 are brought close together so that the surfaces 1100 and 2100 are brought into close proximity of each other preferably from about 0.02 inch to 0.07 inch to form a gap space 3000. Surrounding the plates 1000 and 2000 on the side of the surfaces 1200 and 2200 are thermally insulating materials 4800 which may be made of a combination of materials such as air, fiberglass, silicone, ceramic or structural plastic materials chemically and mechanically stable to over 200 degrees C. such as polytetrafluoroethane (PTFE), PTFE-derived materials, PEEK and the like if the temperature-varying elements 1300 and 2300 are heaters, and heat sink materials such as copper or aluminum blocks with fin-type structures for efficient radiative heat loss. A fan for improving air-cooling of the heat sink is usually installed to further improve the performance of the cooler. When the temperature-varying elements 1300 and 2300 are turned on by a temperature controller such as one using a PID method for setting and maintaining a specific temperature below or above ambient temperatures, the gap space 3000 between the surfaces 1100 and 2100 attains the predetermined temperature indicated by the temperature sensor 1400 so that when one or more capillary columns or coiled capillary columns 6000 are inserted into the gap space 3000, the inserted column or columns 6000 will attain the same predetermined temperature to within 0.5 degree C. In FIG. 3, the housing 4100 for the plate 1000 of the device 500 is made of structural plastic materials and contains mechanical fastening fixtures 4500 for securing the end 6001 of the capillary column 6000 inserted into the gap space 3000. The housing 4100 and 4200 may also be made of thermally conducting materials such as metals as long as the housing is well insulated from the temperature-varying plates 1000 and 2000. The housing 4100 and 4200 may also be made of fabric-like material such as fiberglass, polyimide sheet, Teflon sheet or a combination of these materials to form a flexible and compact device 500. In this case, exits and entrances to the device 500 can be created by simply cutting the fabric cover and the insulation in the appropriate locations of the housing 4100 and 4200 to allow access to the gap space 3000 of the device 500. If the end 6001 of the capillary column is shaped into a tip for nanospray-mass spectrometry, the device 500 can be placed in front of the mass spectrometer inlet and the column end spray tip 6001 can be positioned optimally in front of the mass spectrometer for spraying the eluates into the mass spectrometer directly with minimal post-column dead volume. The fixtures 4500 may be a simple aperture or contains mechanical threads that mate with the nut and ferrule used for connecting capillary columns in the art. More than one fixture 4500 can be incorporated into the housing 4100 to accommodate both ends of the column in the gap space 3000, or more than one column in the same gap space 3000. The fixtures 4500 can also be designed for securing to the device other chromatographic parts such as the union or Tee used for applying high voltage for electrospraying the eluates from the column or columns. The ability of the device 500 to incorporate these fixtures into its body greatly improves the utility of the device 500 for low flow rates liquid chromatography.

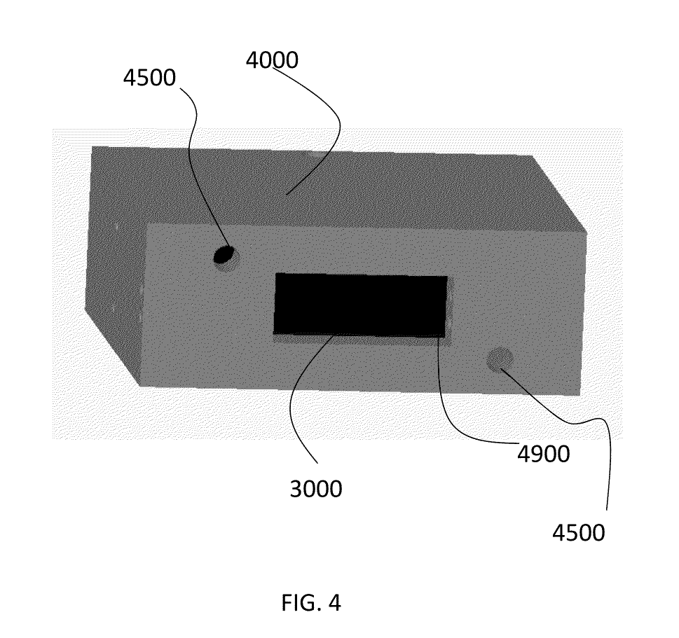

In the embodiment shown in FIG. 3, the insulating materials surrounding the plates 1000 and 2000 except for the surfaces 1100 and 2100 may form two units: one unit 4100 housing the plate 1000 and the second unit 4200 housing the plate 2000. The two units 4100 and 4200 may be stacked together so that the surface 1100 and the surface 2100 face each other and form the gap space 3000, and the units may be clamped together by usual means known in the art. The two units 4100 and 4200 may also be hinged at one end to facilitate easier column installation into the gap space 3000. It should also be obvious to one skilled in the art that the housing of the device may be made of one piece 4000 with an opening 4900 for insertion of the column into the gap space 3000, as depicted in FIG. 4.

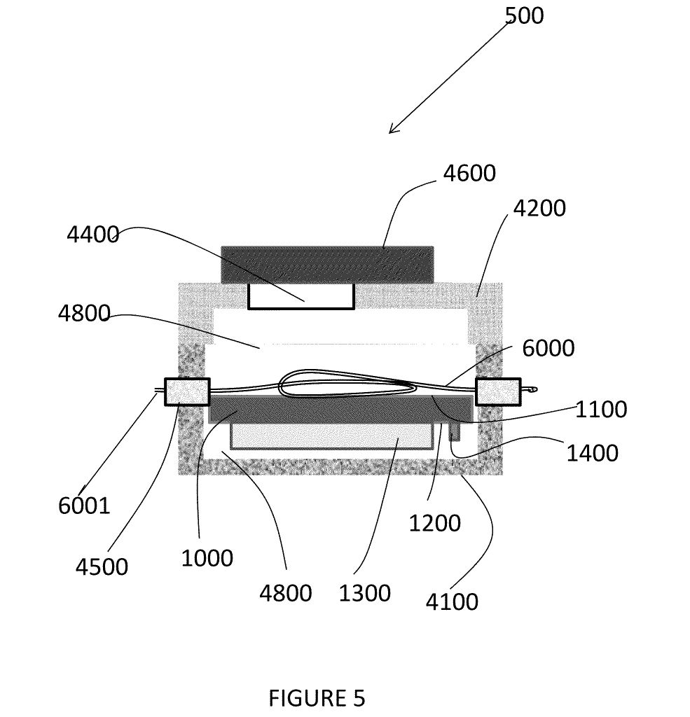

In another embodiment of the invention shown in the cross-sectional schematic drawing in FIG. 5, the distance between the surfaces 1100 and 2100 forming the gap space 3000 is from about 0.03 to about 0.25 inch so that the temperature of the capillary column placed within this space can be quenched quickly to ambient temperatures when the heating elements are turned off or when the unit 4200 is removed from its original position of being in contact with the unit 4100. In this embodiment, the plate 2000 may not be present in the unit 4200, i.e, the unit 4200 contains only thermally insulating materials, which may be air in some cases if the maximum temperature required to be provided by the device is relatively low, for example around 50 degrees C. To help accelerate the quenching of the gap space temperature, the unit 4200 has a large hole 4400 which may constitute up to 30% of the area of the unit 4200. The hole 4400 allows a substantial amount of air from the gap space 3000 to go freely into and out of the gap space 3000. A fan 4600 may be mounted on the outer surface 4200 to draw ambient air through the space 3000 to quench the temperature of the column placed in the gap space 3000. This embodiment is especially useful for applications such as hydrogen/deuterium exchange in proteins in which the device is placed within a cold box and the materials inside the capillary undergo temperature cycling.

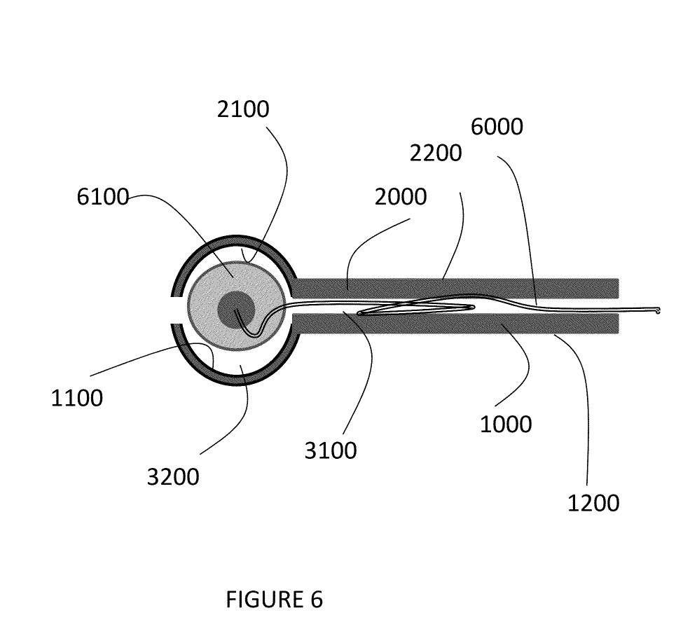

In still another embodiment of the invention as shown in FIG. 6 without the housing cover 4100 and 4200, the plates 1000 and 2000 are not flat but are rolled into a semi-circular form with a diameter of up to 0.5 inch. In this embodiment, the gap space 3000 is not more or less uniform in width but contains two regions where one region 3100 has a width of about 0.02 inch to 0.25 inch, and the second region 3200 has a gap width of about 0.25 inch to 0.5 inch. The gap space region 3200 can accommodate a trap column 6100 with its fittings. For thin plate material, for example, plate thickness between 0.003″ to 0.02″, used in fabricating plate 1000 and 2000 and with the housing 4100 and 4200 made of flexible fabric materials, it may not be necessary to roll the plates 1000 and 2000 into specific shapes since the plates 1000 and 2000 and the housing cover 4100 and 4200 can conform to the shape of the fittings. In this embodiment the device 500 can be used for heating columns of different diameters and different lengths, and also the fittings attached to the end of the column. The gap space regions of 3100 and 3200 may also be created by folding a single plate 1000 appropriately.

In still another embodiment of the invention, the plate 2000 is a Peltier element with the surface 2100 being the cold side of the element. Heat sink materials such as metal blocks and finned metal blocks are used to remove the heat generated on the surface 2200. External fan or fans are usually needed to facilitate the heat removal from the heat sink materials.

While the invention has been particularly shown and described with reference to preferred embodiments thereof, it will be understood by those skilled in the art that various changes in form and details may be made therein without departing from the spirit and scope of the invention.

### Utility

The invention described in this application can be used to heat one or more than one capillary liquid chromatography columns of various lengths to a temperature of about 10° C., which may be quenched very quickly to ambient temperatures. The device in this invention can also be configured to cool the capillary column or columns placed in the device to temperatures substantially below ambient temperatures. The disclosed devices can be used to vary the temperatures of one or more chromatographic columns, fittings, accessories for low flow-rate liquid chromatography without having to remove the column from its usual position in front of the mass spectrometer.

What is claimed is:

1) A device suitable for use to heat or cool a capillary tube used in a liquid chromatography system
comprising:
at least one temperature-varying surface that can be placed in good thermal contact with a part of or the whole capillary tube;
at least one entrance and one exit opening for the capillary tube;
at least one active temperature-varying element;
at least one temperature sensor;
at least two layers of thermal insulation where two of the layers of insulation are in the form of concentric tubes with a slit down the length of each tube; and
a housing cover.

2) The device of claim 1, where the temperature sensor is in good thermal communication of the heated air of the temperature-varying surface.

3) The device of claim 1, where the thermal insulation in the form of two concentric tubes made of a high temperature thermoplastic, and each concentric tube can be moved with respect to the other to form a continuous thermal insulation layer over the inner-most heater tube.

4) The device of claim 1 where the active temperature-varying element to heat the temperature-varying surface is a resistive heating element.

5) A device suitable for use to heat or cool a capillary tube and fittings in a liquid chromatography system
Comprising:
at least one metallic temperature-varying plate that can be placed in good thermal contact with at least a part of the capillary column or the entire capillary column and its fittings;
at least one active temperature-varying element in good thermal contact with a temperature-varying plate;
at least one temperature sensor;
at least one layer of flexible thermal insulation on each temperature-varying plate;
a housing cover over the thermal insulation; and
entrances and exits built into the housing cover for fittings to secure the ends of the capillary column.

6) A device of claim 5, where the temperature-varying surface is folded so that the folded surface facing each other forms a gap space where the capillary tubing and fittings can be placed.

7) The device of claim 5, where the housing cover is a continuous piece over the temperature-varying plates.

8) A device of claim 7 where at least half of the folded surface is in good thermal contact with an active temperature-varying element.

9) A device of claim 5, where an active temperature-varying element is a resistive heater.

10) A device of claim 5, where an active temperature-varying element is a Peltier device.

11) A device of claim 5, where the active temperature-varying elements are a resistive heater and a Peltier plate.

12) A device of claim 9, where a fan is used to quickly lower the heater temperature.

13) A device of claim 5, where the housing cover is made of a flexible fabric material.

14) A device of claim 13, where the housing cover is made of Telfon®-backed fiber-glass sheet.

15) A device of claim 13, where the thickness of the device including the insulation and the housing cover together is less than 1 inch.

16) A device of claim 5, where the housing cover is made of a thermoplastic.

17) A device of claim 5 where the temperature-varying plate is made of copper sheet 0.005 inch to 0.03 inch in thickness.
